(19) United States
(12) Patent Application Publication
(10) Pub. No.: US 2005/0222293 A1
(43) Pub. Date: Oct. 6, 2005

(54) Curable resin composition, method for manufacture of laminate using the composition, transfer material, method for manufacture thereof and transferred product

(75) Inventors: Takahiro Kitano, Tsukuba-shi (JP); Hirokazu Suzuki, Tsukuba-shi (JP); Keiji Kubo, Tsukuba-shi (JP); Masayasu Ogushi, Tsukuba-shi (JP); Kazutoshi Terada, Kurashiki-shi (JP); Tsuneo Kawabata, Kyoto-shi (JP); Masaki Kojima, Kakogawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Co., Ltd., Kurashiki-shi (JP)

(21) Appl. No.: 11/136,368

(22) Filed: May 25, 2005

Related U.S. Application Data
(63) Continuation of application No. 10/412,313, filed on Apr. 14, 2003.

(30) Foreign Application Priority Data
Apr. 18, 2002 (JP) 2002-116333
Apr. 18, 2002 (JP) 2002-116374

(51) Int. Cl. C08G 2/00

(52) U.S. Cl. 522/6

(57) ABSTRACT

A curable resin composition with excellent thermal adhesiveness is constituted of the following components (A) to (C): (A) a thermoadhesive polymer; (B) an ethylenic unsaturated compound polymerizable by active energy radiation; and (C) a polymerization initiator, wherein the relationships represented by the following formulas (1) and (2) are satisfied:
0.1≦(Awt)/{(Awt)+(Bwt)}≦0.6 (1)
0.4≦(Bwt)/{(Awt)+(Bwt)}≦0.9 (2) where (Awt) stands for a compounded amount (parts by weight) of component (A), and (Bwt) stands for a compounded amount (parts by weight) of component (B).

### BACKGROUND OF THE INVENTION

1. Field of the Invention

The present invention relates to a curable resin composition and to a method for the manufacture of a laminate using the composition, more specifically to a curable resin composition demonstrating excellent thermal adhesiveness after curing and a method for the manufacture of a laminate using such a composition. Furthermore, the present invention also relates to a transfer material comprising a release base film and a transfer layer provided thereon, to a method for the manufacture of the transfer material, and to a transferred product, more specifically to a transfer material in which a transfer layer comprising a cured resin layer having both the hard coat function and the thermal transfer function at the same time is provided on a release base film, to a transfer material comprising a homogeneous cured resin layer which is free of “cissing”, “pinholes”, and the like, even in the cases when “cissing” and “pinholes” are easily induced during coating of a typical photocurable resin composition on the surface of the release base film itself or the processed surface thereof, to a method for the manufacture of such transfer materials, and to a transfer product obtained from those transfer materials.

2. Description of the Related Art

Adhesive layers used in laminated materials are usually formed by coating a thermoplastic resin on a laminate substrate material. During coating, the thermoplastic resin has to be melted to reduce the viscosity thereof. In this case, in order to facilitate coating, a viscosity-reducing agent such as wax and the like is added to the thermoplastic resin and the melt viscosity is decreased. The problem is, however, that the adhesive strength of the adhesive layer that was formed is decreased.

To resolve this problems a hot-melt resin composition has been suggested (Japanese Patent Application Laid-open S52-129750) in which a photocurable monomer was added as a viscosity-reducing curing agent to a thermosetting resin, this resin composition having a sufficiently low melt viscosity, though no viscosity-reducing agent such as wax or the like was used, and producing a coating film with good thermal adhesiveness.

Further, an antireflective function has recently become one of important required characteristics of image display panels. The antireflective function reduces the reflection of light, such as light of indoor fluorescent lamps, reflected on the image display panels and allows brighter images to be displayed. The antireflective function is based on the following principle. Forming an antireflective film of a structure in which a layer with a low refractive index is provided on the surface of a layer with a high refractive index makes it possible to reduce the reflection of light by using the difference in optical paths between the light reflected by the high-refractive layer and the light reflected by the low-refractive layer and to cause mutual interference thereof.

The conventional antireflective films having such an antireflective function have been usually fabricated by successively laminating high-refractive layers and low-refractive layers on a plastic substrate material by a dip method. However, because such a process was conducted in a batch mode, the production efficiency was low, causing cost increase in the fabrication of antireflective films. Further, when the dip coating method was employed, the speed of pulling the plastic substrate from the dipping liquid could easily cause non-uniformity of film thickness and a homogeneous micron-order film was usually difficult to obtain.

Accordingly, methods for thermal transfer or pressure sensitive transfer (that is, transfer methods) of a functional layer (transfer layer) formed on a release material onto the surface of a transfer substrate attracted much attention as methods for continuously forming function layers such as homogeneous micron-order antireflective films and the like. For example, methods were suggested for transferring an antireflective film by the transfer method, those methods transferring a transfer material comprising a transfer layer comprising an antireflective layer composed of at least one low-refractive layer, a hard coat layer, and an adhesive layer (that is, comprising at least three layers) (Japanese Patent Applications Laid-open. Nos. H10-16026 and H11-288225). A transfer material composed of two layers, an antireflective layer and an adhesive layer, has also been suggested (Japanese Patent Application Laid-open No. H8-248404).

However, the base polymer used in the hot-melt resin composition suggested in the Japanese Patent Application Laid-open No. S52-129750 is a thermoplastic resin with a high polarity, such as PVA and the like. Therefore, the problem is that this resin has low compatibility with acrylic monomers, which are the photocurable monomers, and the photocurable monomers cannot be added to be 30 wt. % or over in the solids (components that become solid after curing) of the hot-melt resin composition. For this reason, though the photocurable monomers have been blended, the hot-melt resin composition had to be melted during coating and there was a risk of the monomers evaporating or polymerizing during melting.

Further, when a laminated material comprising a hard coat layer used to increase abrasion resistance is laminated on a substrate material, the problem associated with the hot-melt resin composition suggested in Japanese Patent Application Laid-open No. S52-129750 is that the surface hardness of the adhesive layer is low, causing degradation of the laminated layer performance.

On the other hand, with the methods disclosed in Japanese Patent Applications Laid-open Nos. H10-16026 and H11-288225, when adhesion between the adhesive layer and high-refractive layer was insufficient, an additional interlayer was required between those layers, resulting not only in a more complex layered structure, but also in the raised production cost of antireflective films. Further, in the case of the transfer material described in Japanese Patent Application Laid-open No. H8-248404, the transfer layer has no hard coat properties and a three-layer configuration similar to those described in Japanese Patent Applications Laid-open Nos. H10-16026 and H11-288225 is required to provide the hard coat properties. Accordingly, transfer materials have been sought which comprise functional layers capable of reducing the layered structure with the object of lowering production cost in the above-described conventional transfer methods.

Further, a layer of a polyorganosiloxane-derived material with predominantly siloxane bonds was often used for the low-refractive layer in the fabrication of the transfer material having a transfer layer comprising a layer with the antireflective function, but the problem was that because the wettability of the layer of a polyorganosiloxane-derived material with predominantly siloxane bonds is almost insufficient, “cissing” and “pinholes” appear when a coating film of a photocurable resin composition designed for forming a high-refractive layer was formed on the aforesaid layer and a homogeneous coating film was difficult to be formed. Such a problem was not limited to transfer materials comprising a layer with the antireflective function and the market also demanded improvement of transfer materials for other applications (for example, applications requiring a hard coat function, an electrostatic function, and the like).

### SUMMARY OF THE INVENTION

The present invention resolves the above-descried problems inherent to the prior art technology and it is a first object of the present invention to provide a curable resin composition that can be coated at normal temperature and produces a cured product having a high surface hardness and demonstrating thermal adhesiveness, without using a viscous-reducing agent such as wax and the like. It is a second object of the present invention to provide a transfer material comprising a cured resin layer having both the hard coat function and the thermal transfer function at the same time, a transfer material comprising a homogeneous cured resin layer which is free of “cissing”, “pinholes”, and the like, even in the cases when “cissing” and “pinholes” are easily induced during coating of a typical photocurable resin composition on the surface of the release base film itself or the processed surface thereof, to a method for the manufacture of such transfer materials, and to a transfer product obtained from those transfer materials.

The inventors have conducted a comprehensive research of the above-described problems and have found that a cured product of a curable resin composition has good thermal adhesiveness if the curable resin composition is composed of a thermoadhesive polymer, an ethylenic unsaturated compound polymerizable by active energy radiation, and a polymerization initiator and if the compounding ratio of the thermoadhesive polymer and ethylenic unsaturated compound is within a specific range. This finding led to the completion of the first aspect of the present invention. It was also found that the cured product of such a curable resin composition demonstrates not only good thermal adhesiveness, but also good hardness. This finding led to the creation of the second aspect of the present invention.

Thus, in accordance with the first aspect of the present invention there is provided a curable resin composition comprising the following components (A), (B) and (C):
(A) a thermoadhesive polymer;
(B) an ethylenic unsaturated compound polymerizable by active energy radiation; and
(C) a polymerization initiator, wherein the relationships represented by the following formulas (1) and (2) are satisfied:
   0.1≦(Awt)/{(Awt)+(Bwt)}≦0.6 (1)
   0.4≦(Bwt)/{(Awt)+(Bwt)}≦0.9 (2)
   where (Awt) stands for a compounded amount (parts by weight) of component (A), and (Bwt) stands for a compounded amount (parts by weight) of component (B).

In accordance with the first aspect of the present invention, there is also provided a method for the manufacture of a laminate in which a cured resin layer is formed on a substrate material, this method comprising the following steps (a) and (b) of:
(a) forming a coating film composed of the above-described curable resin composition in accordance with the present invention on a substrate material; and
(b) forming a cured resin layer with excellent thermal adhesiveness by irradiating the coating film composed of the curable resin composition thus obtained with active energy radiation, thereby polymerizing the ethylenic unsaturated compound of (B) contained in the coating film composed of the curable resin composition.

In accordance with the second aspect of the present invention, there is provided a transfer material comprising a release base film and a transfer layer provided thereon, wherein the transfer layer comprises at least one thermoadhesive cured resin layer composed of the above-described curable resin composition in accordance with the present invention and the thermoadhesive cured resin layer is disposed on the outermost surface on the side opposite to the release base film.

Further, in accordance with the second aspect of the present invention there is provided a method for the manufacture of a transfer material comprising a release base film and a transfer layer comprising a cured resin layer provided on the release base film, the method comprising the following steps (a′) and (b′) of
(a′) forming a film of the above-described curable resin composition in accordance with the first aspect of the present invention on the release base film; and
(b′) forming a thermoadhesive cured resin layer by irradiating the film of the curable resin composition thus obtained with active energy radiation.

### DETAILED DESCRIPTION OF THE INVENTION

The first aspect of the present invention will be described hereinbelow in greater detail.

The curable resin composition in accordance with the first aspect of the present invention comprises the following components (A), (B) and (C):
(A) a thermoadhesive polymer;
(B) an ethylenic unsaturated compound polymerizable by active energy radiation; and
(C) a polymerization initiator, wherein the relationships represented by the following formulas (1) and (2) has to be satisfied:
   0.1≦(Awt)/{(Awt)+(Bwt)}≦0.6 (1)
   0.4≦(Bwt)/{(Awt)+(Bwt)}≦0.9 (2)
   where (Awt) stands for a compounded amount (parts by weight) of component (A), and (Bwt) stands for a compounded amount (parts by weight) of component (B). From the standpoint of improving adhesiveness and mechanical properties of the cured resin layer the curable resin composition is preferred in which the relationships represented by the following formulas are satisfied:
   0.15≦(Awt)/{(Awt)+(Bwt)}≦0.3 (5)
   0.7≦(Bwt)/{(Awt)+(Bwt)}≦0.85 (6)

In the above-formulas, if the numerical value of (Awt)/{(Awt)+(Bwt)} is less than 0.1, the adhesive strength of the cured layer during curing of the curable resin composition becomes insufficient. On the other hand, if this numerical value is above 0.6, the relative content ratio of the ethylenic unsaturated compound of component (B), is reduced and there is a possibility of mechanical properties of the cured resin layer being degraded. Furthermore, if the numerical value of (Bwt)/{(Awt)+(Bwt)} is less than 0.4, the content ratio of the ethylenic unsaturated compound of component (B), is reduced and there is a possibility of mechanical properties of the cured resin layer being degraded. On the other hand, if this numerical value exceeds 0.9, the relative amount of thermoadhesive polymer of component (A), decreases and the adhesive strength of the cured layer becomes insufficient.

Further, from the standpoint of improving thermal adhesiveness and hardness, it is preferred that the relationship represented by the following formula (3) be satisfied in the aforesaid curable resin composition:
1≦v≦6 (3)
where v (mol/L) is the average of crosslinking density of component (A) and component (B). It is even more preferred that the average value (v) of crosslinking density is within the range of 1 to 4.5.

Further, from the standpoint of improving adhesion to the transfer substrate composed of a methacrylic resin or the like, it is preferred that the relationship represented by the following formula (4) be satisfied in the curable resin composition according to the first aspect of the present invention:
9.5≦δ≦11 (4)
where δ is the average value of solubility parameter (sp value) of component (A) and component (B). It is even more preferred that the average value (δ) of solubility parameter (sp value) be within a range of 9.5 to 10.5.

The thermoadhesive polymer of component (A) used in the above-described curable resin composition is a component providing the curable resin composition with thermal adhesiveness. No specific limitation is placed on such a thermoadhesive polymer, on the condition that it can provide the cured resin layer with thermal adhesiveness. However, it is preferred that the thermoadhesive polymer have a glass transition temperature (at least one glass transition temperature when the polymer has a plurality of glass transition temperatures) of no less than 60° C. and no higher than 180° C., more preferably, no less than 80° C. and no higher than 140° C., because such polymers have excellent thermal adhesiveness and excellent compatibility with the ethylenic unsaturated compound of component (B) described below. Further, from the standpoint of increasing compatibility with the ethylenic unsaturated compound of component (B), it is even more preferred that the thermoadhesive polymer be non-soluble in water.

Specific examples of such thermoadhesive polymer of component (A) include methyl methacrylate polymers, styrene polymers, polyacrylonitrile, polyvinyl chloride, polyvinyl acetate, polyesters, random copolymers, block copolymers, and graft copolymers comprising those polymers, and the like. Among them, for example, when bonding is made to a methacrylic resin sheet, polymers comprising methyl methacrylate unit as the main component are preferred from the standpoint of affinity to the substrate.

When the curable resin composition for forming the cured resin layer is coated on a layer having a low-wettability surface where “cissing” or “pinholes” can be easily induced, it is preferred that a polymer that is in a gel form in a non-cured state, such as a mixture of methyl methacrylate polymer with a high content of isotactic component (“isotactic” is sometimes represented hereinbelow as “iso-”) and methyl methacrylate polymer with a high content of syndiotactic component (“syndiotactic” is sometimes represented hereinbelow as “syn-”), be used as the thermoadhesive polymer of component (A). In such a mixture, for example, it is preferred that isotacticity of the iso-poly(methyl methacrylate) be no less than 50% and syndiotacticity of the syn-poly(methyl methacrylate) be within a range of 40 to 80%, it is more preferred that the isotacticity of the former be no less than 80% and the syndiotacticity of the latter be within a range of 50 to 70%, and it is even more preferred that the isotacticity of the former be no less than 90% and the syndiotacticity of the latter be within a range of 50 to 70%. As for the mixing ratio of iso-poly(methyl methacrylate) and syn-poly(methyl methacrylate), for example, in order to facilitate the initiation of pseudocrosslinking between the molecular chains, the weight ratio of syn-poly(methyl methacrylate) is preferably within a range of 30 to 70 wt. %, more preferably, within a range of 60 to 70 wt. %, when the total weight of iso-poly(methyl methacrylate) and syn-poly(methyl methacrylate) is assumed to be 100 wt. %.

No specific limitation is placed on the polymerizable ethylenic unsaturated compound of component (B) constituting the curable resin composition according to the first aspect of the present invention, provided that the cured layer composed of the curable resin composition demonstrates thermal adhesiveness. Examples of such on the polymerizable ethylenic unsaturated compounds include compounds with at least two ethylene-type double bonds in a molecule, those compounds being polymerizable by irradiation with active energy radiation (for example, UV radiation, visible light, electron beams, X rays, and the like), in the presence of a polymerization initiator. If necessary, vinyl ether compounds, epoxy compounds, or oxetane compounds which are cationically polymerizable in the presence of a catalytic compound or without such can be used in combination with the above-mentioned compound. In the present specification, acryloyl group and methacryloyl group, acrylate group and methacrylate group, and acrylic acid and methacrylic acid are sometimes presented in an abbreviated form of (meth)acryloyl group, (meth)acrylate group, and (meth)acrylic acid, respectively.

Specific examples of polymerizable ethylenic unsaturated compound of component (B) include: (meth)acrylic acid; monofunctional(meth)acrylate monomers such as methyl(meth)acrylate, ethyl(meth)acrylate, propyl(meth)acrylate, n-butyl(meth)acrylate, t-butyl(meth)acrylate, 2-ethylhexyl(meth)acrylate, n-nonyl(meth)acrylate, cyclohexyl(meth)acrylate, benzyl(meth)acrylate, dicyclopentenyl(meth)acrylate, 2-dicyclopentenoxyethyl(meth)acrylate, glycidyl(meth)acrylate, methoxyethyl(meth)acrylate, ethoxyethyl(meth)acrylate, butoxyethyl(meth)acrylate, methoxyethoxyethyl(meth)acrylate, ethoxyethoxyethyl(meth)acrylate, tetrahydrofurfuryl(meth)acrylate, 2-hydroxyethyl(meth)acrylate, 2-hydroxypropyl(meth)acrylate, 4-hydroxybutyl(meth)acrylate, phenoxyethyl(meth)acrylate, phenoxyethoxyethyl(meth)acrylate, biphenoxyethyl(meth)acrylate, biphenoxyethoxyethyl(meth)acrylate, norbornyl(meth)acrylate, phenylepoxy(meth)acrylate, (meth)acryloylmorpholine, N-[2-(meth)acryloylethyl]-1,2-cyclohexanedicarbimide, N-[2-(meth)acryloylethyl]-1,2-cyclohexanedicarbimido-1-en, N-[2-(meth)acryloylethyl]-1,2-cyclohexanedicarbimido-4-en, γ-(meth)acryloyl oxypropyl trimethoxysilane, and the like; vinyl monomers such as N-vinylpyrrolidone, N-vinylimidazole, N-vinylcaprolactam, styrene, α-methylstyrene, vinyltoluene, allyl acetate, vinyl acetate, vinyl propionate, vinyl benzoate, and the like; difuncitonal(meth)acrylates such as 1,4-butanediol di(meth)acrylate, 1,6-hexanediol di(meth)acrylate, 1,9-nonanediol di(meth)acrylate, neopentyl glycol di(meth)acrylate, neopentyl glycol pivalic acid ester di(meth)acrylate, ethylene glycol di(meth)acrylate, polyethylene glycol di(meth)acrylate, triethylene glycol di(meth)acrylate, polypropylene glycol di(meth)acrylate, bisphenol A diglycidyl ether di(meth)acrylate, bisphenol-A-diepoxy di(meth)acrylate, ethylene oxide-modified bisphenol-A-di(meth)acrylate, ethylene oxide-modified diacrylate of 1,4-cyclohexanedimethanol, zinc di(meth)acrylate, bis(4-(meth)acrylthiophenyl)sulfide, and the like; polyfunctional monomers with a functionality of three or more, such as trimethylolpropane tri(meth)acrylate, ditrimethylolpropane tetra(meth)acrylate, pentaerythritol tetra(meth)acrylate, pentaerythritol penta(meth)acrylate, pentaerythritol hexa(meth)acrylate, ethylene oxide-trimethylolpropane adduct tri(meth)acrylate, ethylene oxide-ditrimethylolpropane adduct tetra(meth)acrylate, propylene oxide-trimethylolpropane adduct tri(meth)acrylate, propylene oxide-ditrimethylolpropane adduct tetra(meth)acrylate, ethylene oxide-pentaerythritol adduct tetra(meth)acrylate, propylene oxide-pentaerythritol adduct tetra(meth)acrylate, dipentaerythritol penta(meth)acrylate, ethylene oxide-dipentaerythritol adduct penta(meth)acrylate, propylene oxide-dipentaerythritol adduct penta(meth)acrylate, dipentaerythritol penta(meth)acrylate, dipentaerythritol hexa(meth)acrylate, ethylene oxide-dipentaerythritol adduct hexa(meth)acrylate, propylene oxide-dipentaerythritol adduct hexa(meth)acrylate, triallyl cyanurate, triallyl isocyanurate, triallyl formal, 1,3,5-triacryloylhexahydro-s-triazine, and the like; and oligoacrylates such as urethane acrylates, ester acrylates, and the like. Among them, polyfunctional monomers with a functionality of no less than two are preferably used. Those ethylenic unsaturated compounds can be used individually or in combinations of two or more thereof.

Further, if necessary, vinyl ether compounds, epoxy compounds, or oxetane compounds which are polymerizable by active energy radiation may be used together with the ethylenic unsaturated compound of component (B).

Specific examples of the vinyl ether compounds include ethylene oxide-modified bisphenol A divinyl ether, ethylene oxide-modified bisphenol F divinyl ether, ethylene oxide-modified catechol divinyl ether, ethylene oxide-modified resorcinol divinyl ether, ethylene oxide-modified hydroquinone divinyl ether, ethylene oxide-modified 1,3,5-benzenetriol trivinyl ether, and the like.

Specific examples of the epoxy compounds include 1,2-epoxycyclohexane, 1,4-butanediol diglycidyl ether, 3,4-epoxycyclohexylmethyl-3′,4′-epoxycyclohexane carboxylate, trimethylolpropane diglycidyl ether, bis(3,4-epoxy-6-methyl cyclohexylmethyl) adipate, phenol novolak glycidyl ether, bisphenol A diclycidyl ether, and the like.

Furthermore, specific examples of oxetane compounds include 3-ethyl-3-hydroxymethyloxetane, 3-ethyl-3-(phenoxymethyl)oxetane, di[1-ethyl(3-oxetanyl)]methyl ether, 3-ethyl-3-(2-ethylhexyloxymethyl)oxetane, and the like.

It is further preferred, as described above, that the condition represented by formula (3) below is satisfied in the curable resin composition according to the first aspect of the present invention:
1≦v≦6 (3)
where v (mol/L) is the average of crosslinking density of the above-described component (A) and component (B).

The average (v) of crosslinking density is an indicator of surface hardness of the cured material and can be calculated by the following method.

If the content (parts by weight) of component (A) is denoted by (Awt), the content (parts by weight) of component (B) is denoted by (Bwt), the number of functional groups per one molecule of each component (B) in a resin composition with component (B) comprising ethylenic unsaturated compounds of n types polymerizable by active energy radiation is denoted by fn (n=1, 2, . . . n), the molecular weight of each component (B) is denoted by Mwn (n=1, 2, . . . n), the molar fraction (mol %) of each component (B) in the component (B) is denoted by Rn (n=1, 2, . . . n), the average molecular weight of component (B) is denoted by Mwb, the average density (mol/L) of functional groups of component (B) is denoted by fb, the crosslinking density (mol/L) of component (B) is denoted by vb, and the average value (mol/L) of crosslinking density of component (A) and component (B) is denoted by v, then the average value (v) of crosslinking density can be represented by the following formula.
(v)=(vb)×(Bwt)/(Awt+Bwt)
where (vb), fb, and Mwb can be represented by the following formulas:
(vb)=((fb)−1)×2×1000/(Mwb)
fb=Σ{(fn)×Rn/100}
Mwb={(Mwn)×Rn/100}

For example, when the average (v) of crosslinking density is calculated for a polymer composition comprising 30 parts by weight of poly(methyl methacrylate) (PMMA) as component (A) and 56 parts by weight of trimethylolpropane triacrylate (TMPTA) and 14 parts by weight of pentaerythritol tetracrylate (PETA) as component (B), then, first, fb and Mwb are calculated by using the values shown in the following Table 1.

TABLE 1

| | | | | | R |
|---|---|---|---|---|---|
| | | | f | | (FRACTION |
| | | Mw | (NUMBER OF | wt | IN |
| | COMPONENT | (MOLECULAR | FUNCTIONAL | PARTS BY | COMPONENT |
| | CLASS | WEIGHT) | GROUPS) | WEIGHT) | (B)) |
| PMMA | COMPONENT A | — | — | 30 | — |
| TMPTA | COMPONENT B | 296.3 | 3 | 56 | 82.6 |
| PETA | COMPONENT B | 352.3 | 4 | 14 | 17.3 |

fb = (3 × 82.6/100 + 4 × 17.3/100) = 3.2
Mwb = (296.3 × 82.8/100 + 352.3 × 17.3/100) = 305.7

Then, (vb) is found from the values of fb and Mwb thus obtained and the average value (v) of crosslinking density is found from the obtained (vb).
(vb)=(3.2−1)×2×1000/305.7=14.2
(v)=14.4×70/(30+70)=9.9

Further, as described above, if the average value of solubility parameter (sp value) of component (A) and component (B) is denoted by δ, then the relationship described by the following formula (4) is preferably satisfied:
9.5≦δ≦11.00 (4)

Here, the average value (δ) of solubility parameter (sp value) is an indicator showing the adhesiveness to a substrate material and can be calculated as described below.

Thus, the solubility parameter (sp value) of each component (A) and component (B) can be calculated by using the computation formula suggested by Fedors (Practical Polymer Science (Junji Mukai, Tokuyuki Kanashiro, published by Kodansha Scientific Co., 1981, p. 71-77; POLYMER ENGINEERING AND SCIENCE, FEBRUARY, 1974, VOL. 14, No. 2). For example, the average value of solubility parameter (sp value) of a resin composition composed of components (A) and (B), with a total number of types thereof being n (n is integer of no less than 2), can be found by the following formula
δ=Σ(δn×Rn)
(in this formula, δ is the average value (cal/cm³)^{1/2} of solubility parameter (sp value) of component (A) and component (B), δn is the solubility parameter (sp value: (cal/cm³)^{1/2}) of component (A) and component (B), Rn (n=1, 2, . . . n) is the molar fraction of each component (A) and component (B) in (component (A)+component (B)).

Here δn is represented by the following formula
δn{(Σ(Δei)/Σ(Δvi))}^{1/2}
(in the formula, Δei stands for the evaporation energy (cal/mol) of each atom or atomic group and Δvi stands for the molar volume (cm³/mol) of each atom or atomic group).

Further, for compounds with a glass transition temperature (Tg) of no less than 25° C., the following values are added to molar volume (Δvi).
When n<3, +Δvi=4n
When n≧3, +Δvi=2n
(in the formulas, n stands for a number of atoms in the main chain skeleton in a minimum repeating unit of the polymer).

An example of calculating the average value δ of solubility parameter (sp value) is shown below.

Values of evaporation energy (Δei) of each atom or atomic group and molar volume (Δvi) of each atom or atomic group were taken mainly from Practical Polymer Science (Junji Mukai, Tokuyuki Kanashiro, published by Kodansha Scientific Co., 1981, p. 71-77).

For example, when the average value (δ) of solubility parameter (sp value) of component (A) and component (B) is calculated for a polymer composition comprising 30 parts by weight of poly(methyl methacrylate) (PMMA, Mw 100,000) as component (A) and 56 parts by weight of trimethylolpropane triacrylate (TMPTA) and 14 parts by weight of pentaerythritol tetracrylate (PETA) as component (B), then, first, 6 value of each component (that is, PMMA (δ1), TMPTA (δ2), and PETA (δ3)) are calculated by using fundamental data shown in Tables 2 through 4.

TABLE 2
<PMMA (δ1)>

| | NUMBER OF | | |
|---|---|---|---|
| ATOMIC GROUP | ATOMIC GROUPS | Δei | Δvi |
| CH₃ | 2 | 1125 × 2 | 33.5 × 2 |
| CH₂ | 1 | 1180 | 16.1 |
| CH | 1 | 820 | −1.0 |
| —COO— | 1 | 4300 | 18.0 |
| NUMBER OF ATOMS | 2 | — | 2 × 2 |
| IN MAIN CHAIN | | | |
| SKELETON | | | |

δ1 = {(Σ(Δei)/Σ(Δvi))}^{1/2} = (8550/104.1)^{1/2} = 9.1

TABLE 3
<TMPTA (δ2)>

| | NUMBER OF ATOMIC | | |
|---|---|---|---|
| ATOMIC GROUP | GROUPS | Δei | Δvi |
| CH₃ | 1 | 1125 | 33.5 |
| CH₂ | 4 | 1180 × 4 | 16.1 × 4 |
| C | 1 | 350 | −19.2 |
| CH₂═ | 3 | 1030 × 3 | 28.5 × 3 |
| —CH═ | 3 | 1030 × 3 | 13.5 × 3 |
| —COO— | 3 | 300 × 3 | 18.0 × 3 |

δ2 = {(Σ(Δei)/Σ(Δvi))}^{1/2} = (25275/259.0)^{1/2} = 9.9

TABLE 4
<PETA (δ3)>

| | NUMBER OF ATOMIC | | |
|---|---|---|---|
| ATOMIC GROUP | GROUPS | Δei | Δvi |
| CH₂ | 4 | 1180 × 4 | 16.1 × 4 |
| C | 1 | 350 | −19.2 |
| CH₂═ | 4 | 1030 × 4 | 28.5 × 4 |
| —CH═ | 4 | 1030 × 4 | 13.5 × 4 |
| —COO— | 4 | 4300 × 4 | 18.0 × 4 |

δ3 = {(Σ(Δei)/Σ(Δvi))}^{1/2} = (30510/284.8)^{1/2} = 10.4

δ values for each component described above are shown in Table 5.

TABLE 5

| | COMPONENT | Mw (MOLECULAR | δ | R |
|---|---|---|---|---|
| | CLASS | WEIGHT) | VALUE | (MOL %) |
| PMMA | COMPONENT A | 100 | 9.1 | 56.7 |
| TMPTA | COMPONENT B | 296.3 | 9.9 | 35.8 |
| PETA | COMPONENT B | 352.3 | 10.4 | 7.5 |

Note:
Mw stands for molecular weight of each component (however, in the case of a polymer, it stands for a molecular weight of repeating unit).

Therefore, the average value (δ) of solubility parameter (sp values) of component (A) and component (B) can be found from Table 5 in the manner as follows.
δ=9.1×0.567+9.9×0.358+10.4×0.075=9.5

The polymerization initiator of component (C) constituting the curable resin composition according to the first aspect of the present invention can be appropriately selected according to the type (UV radiation, visible light, electron beams, and the like) of the active energy radiation that is the curing means. Further, when photopolymerization is conducted, it is preferred that a photopolymerization initiator be used and that a well-known photocatalytic compound of at least one type selected from photosensitizers, photoenhancers, and the like be used together therewith.

Specific examples of photopolymerization initiators include 2,2-dimethoxy-2-phenylacetone, acetophenone, benzophenone, xanthofluorenone, benzaldehyde, anthraquinone, 3-methylacetophenone, 4-chlorobenzophenone, 4,4-diaminobenzophenone, benzoin propyl ether, benzoin ethyl ether, benzyl dimethyl ketal, 1-(4-isopropylphenyl)-2-hydroxy-2-methylpropan-1-one, 4-oxyxanthone, camphorquinone, 2-methyl-1-[4-(methylthio)phenyl]-2-morpholinopropan-1-one, and the like. Photopolymerization initiators comprising at least one (meth)acryloyl group in a molecule can be also used.

The content ratio of photopolymerization initiator in the curable resin composition is preferably no less than 0.1 wt. % and no more than 10 wt. %, more preferably, no less than 3 wt. % and no more than 5 wt. % in the solids (also including the components that are solidified after curing) from which the diluting agent has been removed.

In accordance with the first aspect of the present invention, a photosensitizer may be used in combination with the photopolymerization initiator to enhance photopolymerization. Specific examples of photosensitizers include 2-chlorothioxanthone, 2,4-diethylthioxanthone, 2,4-diisopropylthioxanthone, and the like.

Further, in accordance with the first aspect of the present invention, a photoenhancer may be used in combination with the photopolymerization initiator to enhance photopolymerization. Specific examples of photoenhancers include ethyl p-dimethylaminobenzoate, isoamyl p-dimethylaminobenzoate, 2-n-buthoxyethyl p-dimethylaminobenzoate, 2-dimethylaminoethyl benzoate, and the like.

Further a diluting agent can be added to the curable resin composition to coat the curable resin composition as a thin film when a cured resin layer having thermal adhesiveness is formed. In this case, the diluting agent can be added in any amount according to the target thickness of the layer composed of the curable resin composition.

No specific limitation is placed on the diluting agent, provided that it has been used for usual resin coating materials. Examples of suitable diluting agents include ketone compounds such as acetone, methyl ethyl ketone, cyclohexanone, and the like; ester compounds such as methyl acetate, ethyl acetate, butyl acetate, ethyl lactate, methoxyethyl acetate, and the like; ether compounds such as diethyl ether, ethylene glycol dimethyl ether, ethyl cellosolve, butyl cellosolve, phenyl cellosolve, dioxane, and the like; aromatic compounds such as toluene, xylene, and the like; aliphatic compounds such as pentane, hexane, and the like; halogen-based hydrocarbons such as methylene chloride, chlorobenzene, chloroform, and the like; alcohol compounds such as methanol, ethanol, normal propanol, isopropanol, and the like; water, and the like.

A silane compound represented by the following chemical formula (I)
RₙSiX₄₋ₙ (I)
(where R is hydrogen atom, alkyl group (for example, methyl group, ethyl group, propyl group, and the like), aryl group (for example, phenyl group, tolyl group, and the like), an organic group containing a carbon-carbon double bond (for example, acryloyl group, methacryloyl group, vinyl group, and the like), or an organic group containing an epoxy group (for example, epoxycyclohexyl group, glycidyl group, and the like); when two or three R are present, they may be same or different. X is hydroxyl group, alkoxy group (for example, methoxy group, ethoxy group, and the like), alkoxyalkoxy group (for example, methoxyethoxy group, ethoxymethoxy group, and the like) or halogen atom (for example, chlorine atom, bromine atom, iodine atom, and the like); when two or three X are present, they may be same or different. n is integer of 1 to 3) can be further introduced as component (D) into the curable resin composition according to the first aspect of the present invention. Introducing the aforesaid silane compound in the curable resin composition makes it possible to form a homogeneous layer free of “cissing” and “pinholes”, to form a homogeneous film even after curing, and to ensure more tight bonding with a substrate material even when the curable resin composition is coated on the surface of a release base film, layer of material with predominantly siloxane bonds, or substrate material layer which has a surface with a low surface tension and for which tight bonding to the coating material is difficult to ensure.

Specific examples of silane compounds represented by the aforesaid chemical formula (I) include γ-(meth)acryloyloxypropyltrimethoxysilane, γ-epoxypropyltrimethoxysilane, phenyltrimethoxysilane, vinyltrimethoxysilane, ethyltrimethoxysilane, methyltrimethoxysilane, dimethyldimethoxysilane, methyltrichlorosilane, ethyldichlorosilane, and the like.

The content of the silane compound of component (D) in the curable resin composition is preferably about 10-15 wt % based on the solids of the curable resin composition in order to obtain better adhesion of the film.

If necessary, inorganic fillers, polymerization inhibitors, coloring pigments, dyes, antifoaming agents, leveling agents, dispersing agents, light scattering agents, plasticizers, antistatic agents, surfactants, non-reactive polymers, near-IR absorbers, and the like can be added to the curable resin composition for forming a cured resin layer, within ranges that do not degrade the effect of the present invention.

The curable resin composition can be prepared by homogeneously mixing by the usual method the above-described components (A), (B) and (C) and also other components such as component (D) and the like which are added as necessary.

The method for the manufacture of a laminate in which a cured resin layer is formed on a substrate material, according to the first aspect of the present invention, comprises the following steps (a) and (b) of:
(a) forming a coating film composed of the above-described curable resin composition on a substrate material; and
(b) forming a cured resin layer with excellent thermal adhesiveness by polymerizing the ethylenic unsaturated compound of component B contained in the coating film composed of the curable resin composition by irradiating the coating film composed of the curable resin composition thus obtained with active energy radiation.

Thus, the curable resin composition according to the first aspect of the present invention can be advantageously used as a starting material for the cured resin layer in the manufacture of a laminate in which at least the cured resin layer is laminated on a substrate material. Furthermore, such a laminate can be manufactured by the manufacturing method comprising the following steps (a) and (b).

Step (a)

First, a film of the curable resin composition according to the first aspect of the present invention is formed on a substrate material by dip coating process, coating process using a roll employed in relief printing, lithographic printing, intaglio printing, and the like, spraying method in which coating material is sprayed over the substrate material, curtain flow coating process, and the like.

Metal (steel, aluminum, and the like) substrate, ceramic substrates including glass substrates, plastic substrates from acrylic resins, PET, polycarbonates, and the like, thermosetting resin substrates, and the like, in the form of sheets or film can be used as the substrate material.

Further, when a diluting agent (solvent) is contained in the curable resin composition, the diluting agent is preferably removed in advance prior to implementing step (b). In this case, it is usually evaporated by heating.

A heating surface, a far-IR furnace, or an ultrafar-IR furnace can be used for heating.

Step (b)

The film composed of the curable resin composition obtained in process (a) is cured by irradiating with an active energy radiation and a cured resin layer with excellent thermal adhesiveness is formed. As a result, a laminated body in which a uniform and thin (for example, no less than 0.01 μm and no more than 10 μm) cured resin layer is formed on a substrate can be obtained even when a substrate with poor paint wettability is used.

A wide range of radiation types, such as UV radiation, visible radiation, laser, electron beam, X rays, can be used as the active energy radiation. From the standpoint of practical use, it is preferred that among those radiation types the UV radiation be employed. Specific examples of UV radiation sources include low-pressure mercury lamps, high-pressure mercury lamps, xenon lamps, metal halide lamps, and the like.

Further, the laminated body thus obtained does not necessarily have a two-layer structure. Thus, a layer of thermoplastic, thermosetting, or photocurable material may be provided in advance, or it may be provided again after the formation of the cured resin layer.

The cured resin layer composed of the curable resin composition in accordance with the first aspect of the present invention uses a thermoadhesive polymer and has a hard coat function. Therefore, the properties thereof are such that usually the pencil hardness is no less than H and the difference between the haze (AH) values before and after acetone coating is in the range of 0.3 to 40. Properties of such a cured resin layer can be estimated by an acetone resistance test and pencil hardness test.

Because the laminated body comprising the cured resin layer with such properties demonstrate thermal adhesiveness and has a high surface hardness, it can be advantageously applied to goods such as laminated materials and like, which are used for wallpaper and the like.

The transfer material, a method for the manufacture thereof, and a transfer product according to the second aspect of the present invention will be described below.

The transfer material according to the second aspect of the present invention has a structure in which a transfer layer is provided on a release base film. A specific feature of the transfer layer is that it comprises at least one thermoadhesive cured resin layer composed of the curable resin composition according to the first aspect of the present invention and the thermoadhesive cured resin layer is disposed on the outermost surface on the side opposite to the release base film.

In accordance with the second aspect of the present invention, the transfer layer may consist only of the cured resin layer having thermal adhesiveness (only one cured resin layer), or it may have a multilayer structure comprising no less than two layers including a low-refractive layer, a cured resin layer, and the like. For example, the transfer layer may be composed of a cured resin layer demonstrating a hard coat function and a heat transfer function at the same time and a low-refractive layer such as a layer of a material with predominantly siloxane bonds, which has low wettability (water-repellant or oil-repellant), a fluororesin layer, or the like.

Furthermore, according to the object of the transfer material usage, the transfer layer can comprise an antireflective layer composed of a low-refractive layer other than the above-mentioned layer, an antireflective layer composed of a low-refractive layer and a high-refractive layer, a hard coat layer of an acrylic resin, a silicone resin, and the like, a functional layer such as an antibacterial layer or the like, a decorative layer such as a printed layer, a colorant layer, and the like, a deposited layer (electrically conductive layer) composed of a metal or a metal compound, a primer layer, and the like.

Specific examples of the layered structure of the transfer layer include: cured resin layer, low-refractive layer/cured resin layer, low-refractive layer/high-refractive layer/cured resin layer, low-refractive layer/high-refractive layer/vapor-deposited layer/primer layer/cured resin layer, low-refractive layer/high-refractive layer/primer layer/vapor-deposited layer/primer layer/cured resin layer, low-refractive layer/high-refractive layer/primer layer/cured resin layer, ard coat layer/cured resin layer, printed layer/cured resin layer, decorative layer/cured resin layer, and the like.

No specific limitation is placed on the thickness of the cured resin layer, and usually it is appropriately selected from a range of about 0.5-20 μm. Further, no specific limitation is also placed on the thickness of other layers, and usually it is appropriately selected from a range of about 0.1-50 μm.

In order to form the cured resin layer from the curable resin composition, active energy radiation of a wide range of radiation types, such as UV radiation, visible light radiation, α radiation, β radiation, γ radiation, and the like can be used according to the conventional photocuring technology of photopolymerizable resins with respect to the formed film of the curable resin composition. Among those radiation types, the UV radiation is preferably used. A light source of any type, for example, a spot light source, linear light source, surface light source, and the like, can be used, but from the standpoint of practical use, a linear light source is typically employed. For example, a UV lamp is typically used as a UV generation source because of its utility and cost efficiency. Specific examples of such UV lamps include low-pressure mercury lamps, high-pressure mercury lamps, xenon lamps, metal halide lamps, and the like. Further, when a spot light source of linear light source is used, scanning may be appropriately employed so as to illuminate the layer composed of a photocurable resin composition with the prescribed light.

The transfer material according to the second aspect of the present invention comprises a release base film and a transfer layer provided thereon, and the transfer layer comprises at least a cured layer composed of the curable resin composition according to the first aspect of the present invention. Further, the transfer layer may be composed only of the cured resin layer, or can have a cured resin layer and at least one layer selected from an antireflective layer composed of a low-refractive layer, an antireflective layer composed of a low-refractive layer and a high-refractive layer, a hard coat layer of an acrylic resin, a silicone resin or the like, a functional layer such as an antibacterial layer, an electrically conductive layer, and the like, a decorative layer such as a printed layer, a colorant layer, and the like, a deposited layer composed of a metal or a metal compound, a primer layer, and the like.

Specific examples of the layered structure of the transfer material include: release base film/cured resin layer, release base film/low-refractive layer/cured resin layer, release base film/low-refractive layer/high-refractive layer/cured resin layer, release base film/low-refractive layer/high-refractive layer/vapor-deposited layer/primer layer/cured resin layer, release base film/low-refractive layer/high-refractive layer/primer layer/vapor-deposited layer/primer layer/cured resin layer, release base film/low-refractive layer/high-refractive layer/primer layer/cured resin layer, release base film/hard coat layer/cured resin layer, release base film/printed layer/cured resin layer, release base film/decorative layer/cured resin layer, and the like.

No specific limitation is placed on the release base film used in the transfer material according to the second aspect of the present invention, and any film can be used provided that it has release and sufficient self-supporting ability and can be used with the usual transfer materials. Specific examples of such release base films include synthetic resin films such as polyethylene terephthalate film, polypropylene film, polycarbonate film, polystyrene film, polyamide film, polyamideimide film, polyethylene film, polyvinyl chloride film, fluororesin film, and the like, man-made resin films such as cellulose acetate film and the like, Western paper such as cellophane paper, glassine paper, and the like, other film-like products such as Japanese paper, composite film-like or sheet-like products composed therefrom, and those products subjected to release treatment.

No specific limitation is placed on the thickness of the release base film, but in order to suppress the formation of wrinkles or cracks, it is usually preferred that the thickness be within a range of 4-150 μm, more preferably, within a range of 12-100 μm, still more preferably, within a range of 30 to 100 μm.

When the release ability of the release base film is insufficient, the release treatment can be conducted on at least one side of the release base film. Such a release treatment can be conducted by the conventional methods by appropriately selecting a release polymer, wax, or the like. Examples of treatment agents used for such release treatment include release waxes such as paraffin waxes and the like, release resins such as silicone resins, melamine resins, urea resins, urea-melamine resins, cellulose resins, benzoguanamine resins, and the like, and surfactants of various types. Those agents can be used individually or upon mixing with a solvent, coated on a release base film by the usual printing method such as gravure printing method, screen printing method, offset printing method, and the like, dried, and cured (heating, UV irradiation, electron beam irradiation, irradiation with ionizing radiation), if necessary.

As described above, a primer layer can be provided in a transfer layer having a multilayer structure in the transfer material according to the second aspect of the present invention. Such a primer layer is a coating layer of a composition based on a polymer component with good adhesion to body layers in the transfer material according to the second aspect of the present invention, this coating layer preferably having a thickness within a range of about 0.5 to 5 μm. Specific examples of the primer layer include layers of acrylic resin, vinyl acetate resin, melamine resin, polyester resin, urethane resin, and the like. Those layers can be formed by dissolving the resin in a solvent, coating by the aforesaid printing method or the like, and drying.

The transfer layer constituting the transfer material according to the second aspect of the present invention can contain, as mentioned hereinabove, a layer of material with predominantly siloxane bonds forming a low-refractive layer. The layer of the material with predominantly siloxane bonds preferably has a low refractive index of no more than 1.5, more preferably, no less than 1.2 and no more than 1.4, excellent transparency, and a pencil hardness after film formation of no less than H.

Specific examples of layers of the material with predominantly siloxane bonds include layers formed from compounds in which part of siloxane bonds is replaced with hydrogen atoms, hydroxyl groups, unsaturated groups, alkoxyl groups and the like. Such layers may be also formed by introducing in advance an agent reducing refractive index, such as ultrafine particles of SiO₂ or the like, into the aforesaid compounds and converting into a resin.

The thickness of the layer of material with predominantly siloxane bonds is usually within a range of from 0.05 μm to 10 μm, more preferably, within a range of from 0.09 μm to 3 μM.

Further, when the transfer layer is composed of a layer of material with predominantly siloxane bonds and cured resin layer, the layer of material with predominantly siloxane bonds can serve as a low-refractive layer and the cured resin layer can serve as a thermoadhesive layer with a high refractive index. Therefore, the transfer material in accordance with the present invention can transfer a good antireflective film.

The transfer material according to the second aspect of the present invention, which comprises a release base film and a transfer layer comprising a cured resin layer provided on the release base film, can be manufactured by the manufacturing method comprising the following steps (a′) and (b′).

Step (a′)

First, a film composed of the aforesaid curable resin composition according of the first aspect of the present invention is formed on a release base film by coating on the surface of the release base film by a process such as a dip coating process, a coating process using a roll employed in relief printing, lithographic printing, intaglio printing, and the like, spraying method in which coating material is sprayed over the substrate material, curtain coating process, and the like, and drying, if necessary.

Further, when a diluting agent (solvent) is contained in the curable resin composition, the diluting agent is preferably removed in advance prior to implementing step (b′). In this case, it is usually evaporated by heating. A heating furnace, a far-IR furnace, or an ultrafar-IR furnace can be used for heating.

Step (b′)

A cured resin layer with excellent surface hardness and thermal adhesiveness is then formed by curing the film composed of the curable resin composition and obtained in step (a′) with active energy radiation. As a result, a transfer material can be obtained in which a homogeneous thin (for example, with a thickness of no less than 0.01 μm and no more than 10 μm) cured resin layer is formed on the substrate material even when the substrate material has poor wettability with coating material.

When a cured resin layer is provided as any of the layers on the base film surface, it is preferably located on the outermost side (outermost layer of the transfer layer).

The cured resin layer composed of the curable resin composition according to the second aspect of the present invention uses a thermoadhesive polymer and has a hard coat function. Therefore, evaluation can be conducted by an acetone resistance test and pencil hardness measurements. The pencil hardness in this case is no less than H and the difference between haze values before and after acetone coating is within a range of 0.3 to 40.

The transfer material according to the second aspect of the present invention can be used for thermally transferring the transfer layer on a transfer substrate by bringing the cured resin layer composed of the curable resin composition (outermost surface) in intimate contact with the transfer substrate and heating. No specific limitation is placed on the shape of the transfer substrate, the preferred examples including commercial resin sheets, films, glass sheets, and the like. In applications as protective sheets for display screens and the like, the transfer substrate is preferably a resin sheet. No specific limitation is placed on the resins of such sheets, provided that they are transparent in a wavelength range of visible light. Examples of preferred resins include methacrylic resins such as poly(methyl methacrylate) (PMMA) and the like, polycarbonate resins, methyl methacrylate-styrene copolymer (MS resin), and the like.

The transferred product obtained by transferring the transfer layer onto the surface of the transfer substrate by using the transfer material according to the second aspect of the present invention can be used in a variety of fields according to chemical and physical properties of the transfer layer. For example, it can be advantageously used as a protective sheet for display screens such as rear projection television sets, plasma display panels, and the like.

Because the cured resin layer composed of the curable resin composition has been also formed on the surface of transfer substrate in the transfer product according to the second aspect of the present invention, the decision as to whether the requirement of the present invention are satisfied can be made, similarly to the above-described case of the transfer material, by exposing the cured resin layer and then conducting the acetone resistance test and pencil hardness measurements. When the requirements according to the second aspect of the present invention are satisfied, the pencil hardness of the cured resin layer is no less than H and the difference between the haze values before and after acetone coating is within a range of 0.3 to 40.

### EXAMPLES

The first and second aspects of the present invention will be described hereinbelow in greater detail based on examples thereof. In the examples, the term “part” stands for “part by weight”, unless stated otherwise. Evaluation in the examples was conducted by the following methods.

Method for Measuring Adhesive Strength

The laminated material obtained was heated and adhesively bonded to a resin sheet at a resin sheet temperature of 90° C., a roll temperature of 160° C., and a sheet feed speed of 1 m/min, a 180° peel test was conducted according to JIS K-6854 (1994), and an adhesive strength was measured.

Measurement of Pencil Hardness

The pencil hardness of the transferred product surface was measured according to JIS K 5600-5-4 (1999).

Measurement of Covered Surface Area

A laminated material was cut to 5 cm×5 cm and divided by marking into 100 sections. The number of sections in which the cured resin layer completely covered the film, with no cissing or pinhole formation being observed, was measured and the result was expressed on a percentage basis (%) as the covered surface area.

Measurement of Transfer Surface Area

The rear surface of the transfer material obtained was divided into 100 sections by marking with a maker, the number of sections in which the transfer layer moved to the transfer substrate over the entire divided area was measured (the number of sections in which the completely coated cured resin layer has moved, with no cissing or pinhole formation being observed), and the transfer surface area was expressed on a percentage basis (%).

Further, thermoadhesive polymers used in the examples, except the commercial products, were synthesized by the following methods.

### Synthesis Example 1

### Preparation of iso-PMMA (Mw 50,000 Isotacticity 93%)

A three-neck flask with a capacity of 300 ml was purged with nitrogen, followed by the addition of 28 ml of toluene, 112 ml of cyclohexane, and 7.4 ml of ether solution (0.77 mole/l) of phenyl magnesium bromide and cooling to a temperature of 10° C.

A total of 30 ml of methyl methacrylate was then dropwise added within 90 minutes, followed by stirring for 6 hours. A total of 0.5 ml of methanol was then added and the reaction was terminated. The reaction liquid was then filtered, the residue was washed with methanol and dried, and iso-PMMA was obtained. The results of GPC measurements showed that the weight-average molecular weight (Mw) was 50,000, and the results of NMR measurements showed that the isotacticity was 93%.

### Synthesis Example 2

### Synthesis of syn-poly n-butyl methacrylate (PnBMA)

A three-neck flask with a capacity of 300 ml was purged with nitrogen, followed by the addition of toluene (100 ml), n-butyl methacrylate (100 ml), azoisobutyronitrile (0.02 g), 1-octanethiol (0.18 g), stirring for 8 hours at a temperature of 60° C., and cooling. The reaction liquid was dropwise added to 2000 ml of methanol, the precipitate obtained was dried, and syn-nBMA PnBMA was obtained. The Mw (weight-average molecular weight) of syn-PnBMA obtained was 37,000, based on the GPC measurement results. Further, isotacticity was 57% based on the NMR measurement results.

### Examples 1 Through 7, Comparative Examples 1 and 2

Photocurable resin compositions were prepared by dissolving 20 parts by weight of compositions (parts by weight) shown in Table 6 in a diluting agent composed of 50 parts by weight of toluene and 30 parts by weight of isopropanol, and those compositions were coated with a bar coater to a thickness of 20 μm on PET films with a thickness of 38 μm and treated to facilitate adhesion, dried for 30 seconds at a temperature of 140° C., and cured by conducting UV irradiation two times (conveyor speed 1 m/min, distance between the light source and irradiation object 10 cm, manufactured by Ushio Co., Ltd.) to form cured transfer layers (thermoadhesive layers) and to obtain laminated materials.

The laminated materials thus obtained were heated and adhesively bonded to methacrylic resin sheets in the above-described method and adhesive strength was measured by conducting a 180° peel test.

Further, the prepared photocurable resin compositions were coated with a bar coater to a thickness of 20 μm on methacrylic resin sheets with a thickness of 2 mm, dried for 30 seconds at a temperature of 140° C., and cured by conducting UV irradiation two times (conveyor speed 1 m/min, distance between the light source and irradiation object 10 cm, manufactured by Ushio Co., Ltd.) to obtain laminated sheets. The surface hardness (pencil hardness) was then measured.

Glass transition temperature (Tg) of each polymer shown in Table 6 was measured with a device TA 4000 manufactured by Mettler Co., Ltd.

TABLE 6

| | | | | | | | | | COMPARATIVE | |
|---|---|---|---|---|---|---|---|---|---|---|
| | Tg | EXAMPLES | | | | | | | EXAMPLES | |
| COMPONENTS | (° C.) | 1 | 2 | 3 | 4 | 5 | 6 | 7 | 1 | 2 |
| PMMA 1*¹ | 128 | 25 | 50 | 0 | 15 | 20 | 25 | 16 | 5 | 0 |
| PMMA 2*¹⁰ | 58 | 0 | 0 | 0 | 0 | 10 | 0 | 9 | 0 | 0 |
| POLYSTYRENE*² | 91 | 0 | 0 | 25 | 0 | 0 | 0 | 0 | 0 | 5 |
| POLYURETHANE*³ | −41,120 | 0 | 0 | 0 | 10 | 0 | 0 | 0 | 0 | 0 |
| EP-MODIFIED BPADA*⁴ | — | 50 | 33 | 50 | 50 | 50 | 25 | 25 | 63 | 63 |
| TRIAZINE TRIACRYLATE*⁵ | — | 0 | 0 | 0 | 0 | 0 | 10 | 10 | 0 | 0 |
| EP-MODIFIED PHENOXYACRYLATE*⁶ | — | 0 | 0 | 0 | 0 | 20 | 20 | 20 | 0 | 0 |
| APTMS*⁷ | — | 0 | 0 | 0 | 0 | 0 | 20 | 20 | 0 | 0 |
| DPEHA*⁸ | — | 25 | 17 | 25 | 25 | 0 | 0 | 0 | 32 | 32 |
| PHOTOPOLYMERIZATION INITIATOR*⁹ | — | 3 | 3 | 3 | 3 | 3 | 3 | 3 | 3 | 3 |
| (Awt)/{(Awt) + (Bwt)} | | 0.25 | 0.5 | 0.25 | 0.25 | 0.30 | 0.25 | 0.25 | 0.05 | 0.05 |
| (Bwt)/{(Awt) + (Bwt)} | | 0.75 | 0.5 | 0.75 | 0.75 | 0.70 | 0.75 | 0.75 | 0.95 | 0.95 |
| v (mol/L) | | 6.0 | 4.1 | 6.0 | 6.0 | 5.2 | 1.9 | 1.9 | 7.8 | 7.8 |
| δ | | 9.9 | 9.4 | 10.6 | 10.5 | 9.8 | 9.9 | 9.9 | 10.9 | 11.1 |
| ADHESIVE STRENGTH (mN/cm) | | 150 | FRACTURE OF | 100 | 50 | 300 | 300 | 300 | 0 | 0 |
| | | | SUBSTRATE | | | | | | | |
| | | | MATERIAL | | | | | | | |
| PENCIL HARDNESS | | 3H | 2H | 3H | 3H | H | H | H | 4H | 5H |

Notes for Table 6.
*¹Trade name: Parapet HR-L, manufactured by Kuraray Co., Ltd. (syndiotacticity 60%)
*²Trade name: Polystyrene (degree of polymerization 3000), manufactured by Wako Pure Chemical Industries Co., Ltd.
*³Trade name: Kuramiron U 1780, manufactured by Kuraray Co., Ltd.
*⁴Trade name: Viscoat #540, manufactured by Osaka Organic Chemical Industry Co., Ltd.
*⁵Trade name: M315, manufactured by Toagosei Chemical Industry Co., Ltd.
*⁶Trade name: M600A, manufactured by Kyoeisha Chemical Co., Ltd.
*⁷Trade name: KBM5103 (γ-acryloyloxypropyl trimethoxysilane), manufactured by Shin-Etsu Chemical Co., Ltd.
*⁸Trade name: DPHA, manufactured by Nippon Kayaku Co., Ltd.
*⁹Trade name: Irgacure 184, manufactured by Japan Ciba-Geigy Co., Ltd.
*¹¹PMMA (Mw 50,000, isotacticity 93%, see Synthesis Example 1).

The results relating to Examples 1 to 7 as shown in Table 6 demonstrate that when a curable resin composition is composed of a thermoadhesive polymer, an ethylenic unsaturated compound, and a photopolymerization initiator and the requirements according to the first aspect of the present invention are satisfied, a coating film can be obtained which shows good adhesive properties and also good surface hardness.

By contrast the results of Comparative Examples 1 and 2 demonstrate that good adhesiveness is not obtained when the requirements according to the first aspect of the present invention are not satisfied.

### Example 8

A mixed solution comprising 14 parts by weight of methyltrimethoxysilane (trade name: KBM13, manufactured by Shin-Etsu Chemical Co., Ltd.), 18 parts by weight of colloidal silica (trade name; MEK-ST, manufactured by Nissan Chemical Industry Co., Ltd.), 0.2 part by weight of acetic acid, and 68 parts by weight of methyl ethyl ketone was coated with a bar coater to a thickness of 20 μm on a PET film having a thickness of 38 μm and treated to facilitate adhesion. The coating was dried for 2 minutes at a temperature of 150° C.

Then, a photocurable resin composition comprising 3 parts by weight of PMMA (trade name: Parapet HR-L, manufactured by Kuraray Co., Ltd.), 2 parts by weight of polyurethane (trade name: Kuramiron U 1780, manufactured by Kuraray Co., Ltd., Tg-41° C., 120° C.), 10 parts by weight of EP-modified BPADA (trade name: Viscoat #540, manufactured by Osaka Organic Chemical Industry Co., Ltd.), 5 parts by weight of DPEHAD (trade name: DPHA, manufactured by Nippon Kayaku Co., Ltd.), 0.6 part by weight of photopolymerization initiator (trade name: Irgacure 184, manufactured by Japan Ciba-Geigy Co., Ltd.), 49.4 parts by weight of toluene, and 30 parts by weight of isopropanol was coated with a bar coater to a thickness of 20 μm on the coated surface of PET film obtained in the above-described manner. The coating was dried for 30 seconds at a temperature of 140° C. and cured by conducting UV irradiation two times (conveyor speed 1 m/min, distance between the light source and irradiation object 10 cm, manufactured by Ushio Co., Ltd.) to form a thermoadhesive layer composed of a cured resin and to obtain a laminated material.

The laminated material thus obtained was cut to 5 cm×5 cm and divided by marking into 100 sections, and the covered surface area of the photocurable resin composition was measured. The result was 100%.

The adhesive strength was then measured by a scaled tape method (JIS K 5400) with respect to the laminated material obtained. The result was 0 point out of 10.

The laminated material obtained was then heated and adhesively bonded to a methacrylic resin sheet (sheet temperature 90° C., roll temperature 160° C., sheet feed speed 1 m/min), a 180° peel test (JIS K 6854) was conducted and the adhesive strength of the thermoadhesive cured resin layer was measured. An adhesive strength of 50 mN/cm was obtained.

### Example 9

A mixed solution comprising 14 parts by weight of methyltrimethoxysilane (trade name: KBM13, manufactured by Shin-Etsu Chemical Co., Ltd.), 18 parts by weight of colloidal silica (trade name; MEK-ST, manufactured by Nissan Chemical Industry Co., Ltd.), 0.2 part by weight of acetic acid, and 68 parts by weight of methyl ethyl ketone was coated with a bar coater to a thickness of 20 μm on a PET film having a thickness of 38 μm and treated to facilitate adhesion. The coating was dried for 2 minutes at a temperature of 150° C.

Then, a photocurable resin composition comprising 3 parts by weight of PMMA (trade name: Parapet HR-L, manufactured by Kuraray Co., Ltd.), 2 parts by weight of polyurethane (trade name: Kuramiron U 1780, manufactured by Kuraray Co., Ltd., Tg-41° C., 120° C.), 9 parts by weight of EO-modified BPADA (trade name: Viscoat #540, manufactured by Osaka Organic Chemical Industry Co., Ltd.), 5 parts by weight of DPEHA (trade name: DPHA, manufactured by Nippon Kayaku Co., Ltd.), 0.6 part by weight of photopolymerization initiator (trade name: Irgacure 184, manufactured by Japan Ciba-Geigy Co., Ltd.), 1 part by weight of methyltrimethoxysilane (trade name: KBM13, manufactured by Shin-Etsu Chemical Co., Ltd.), 49.4 parts by weight of toluene, and 30 parts by weight of isopropanol was coated with a bar coater to a thickness of 20 μm on the coated surface of PET film obtained in the above-described manner. The coating was dried for 30 seconds at a temperature of 140° C. and cured by conducting UV irradiation two times (conveyor speed 1 m/min, distance between the light source and irradiation object 10 cm, manufactured by Ushio Co., Ltd.) to form a thermoadhesive layer composed of a cured resin and to obtain a laminated material.

The covered surface area of the laminated material thus obtained was measured. The result was 100%.

The adhesive strength was then measured by a scaled tape method (JIS K 5400) with respect to the laminated material obtained. The result was 10 points out of 10.

The laminated material obtained was then heated and adhesively bonded to a methacrylic resin sheet (sheet temperature 90° C., roll temperature 160° C., sheet feed speed 1 m/min), a 180° peel test (JIS K 6854) was conducted, and the adhesive strength of the thermoadhesive cured resin layer was measured. An adhesive strength of 30 mN/cm was obtained.

### Example 10

A mixed solution comprising 14 parts by weight of methyltrimethoxysilane (trade name: KBM13, manufactured by Shin-Etsu. Chemical Co., Ltd.), 18 parts by weight of colloidal silica (trade name; MEK-ST, manufactured by Nissan Chemical Industry Co., Ltd.), 0.2 part by weight of acetic acid, and 68 parts by weight of methyl ethyl ketone was coated with a bar coater to a thickness of 20 μm on a PET film having a thickness of 38 μm and treated to facilitate adhesion, and the coating was dried for 2 minutes at a temperature of 150° C.

Then, a photocurable resin composition comprising 5 parts by weight of methacrylic resin (trade name: Parapet HR-L, manufactured by Kuraray Co., Ltd.), 4 parts by weight of EP-modified BPADA (trade name: Viscoat #540, manufactured by Osaka Organic Chemical Industry Co., Ltd.), 2 parts by weight of triazine triacrylate (trade name M315, manufactured by Toagosei Chemical Industry Co., Ltd., 4 parts by weight of EP-modified phenoxyacrylate (trade name: M600A, manufactured by Kyoeisha Chemical Co., Ltd.), 4 parts by weight of APTMS (trade name: KBM5103, manufactured by Shin-Etsu Chemical Co., Ltd.), 0.6 part by weight of photopolymerization initiator (trade name: Irgacure 184, manufactured by Japan Ciba-Geigy Co., Ltd.), 1 part by weight of methyltrimethoxysilane (trade name KBM13, manufactured by Shin-Etsu Chemical Co., Ltd.), 49.4 parts by weight of toluene, and 30 parts by weight of isopropanol was coated with a bar coater to a thickness of 20 μm on the coated surface of PET film obtained in the above-described manner. The coating was dried for 30 seconds at a temperature of 140° C. and cured by conducting UV irradiation two times (conveyor speed 1 m/min, distance between the light source and irradiation object 10 cm, manufactured by Ushio Co., Ltd.) to form a thermoadhesive layer composed of a cured resin and to obtain a laminated material.

The covered surface area of the laminated material thus obtained was measured. The result was 100%.

The adhesive strength was then measured by a scaled tape method (JIS K 5400) with respect to the laminated material obtained. The result was 10 points out of 10.

The laminated material obtained was then heated and adhesively bonded to a methacrylic resin sheet (sheet temperature 90° C., roll temperature 160° C., sheet feed speed 1 m/min), a 180° peel test (JIS K 6854) was conducted, and the adhesive strength of the thermoadhesive cured resin layer was measured. An adhesive strength of 50 mN/cm was obtained.

Acetone was then coated by the method described in JIS K 5600-6-1 to a film thickness of 100 μm on the curable resin layer of the laminated film obtained and the coating was allowed to stay at normal temperature until it dried. The difference (ΔH) between haze values before and after acetone coating was measured. The result was 20.3, the pencil hardness was 2H.

As shown in the above-described Examples 1 through 10, the photocurable resin composition according to the first aspect of the present invention made it possible to obtain thermal adhesiveness and has a high surface hardness and this adhesive can be advantageously applied to the products such as laminated materials and the like that are used in wallpaper and the like.

### Examples 11-17 and Comparative Examples 3-4

Photocurable resin compositions (photocurable resin compositions identical to those used in Examples 1 through 7 and Comparative Examples 1 to 2) prepared by dissolving 20 parts by weight of compositions (parts by weight) shown in Table 6 in a diluting agent composed of 50 parts by weight of toluene and 30 parts by weight of isopropanol were coated with a bar coater to a thickness of 20 μm on bidirectionally stretched polyethylene terephthalate films with a thickness of 38 μm having melamine release layers. The coating was dried for 30 seconds at a temperature of 140° C. and cured by conducting UV irradiation two times with a 80 W high-pressure mercury lamp (conveyor speed 1 m/min, distance between the light source and irradiation object 10 cm, manufactured by Ushio Co., Ltd.) to form transfer layers composed of a cured resin layer and to obtain transfer materials of Examples 11 through 17 and Comparative Examples 3 and 4.

The transfer layers of transfer materials obtained were thermally transferred onto a methacrylic resin sheet under the following conditions: sheet temperature 90° C., roll temperature 160° C., sheet feed speed 1 m/min, and the transfer surface area and pencil hardness were measured. The results obtained are shown in Table 7. Because there was no transfer in Comparative Examples 3 and 4, the photocurable resin compositions were directly coated on the methacrylic resin sheets to a solid film thickness of 4 μm and pencil hardness was measured after curing. The results are presented in the parentheses for reference.

TABLE 7

| | | | | | | | | COMPARATIVE | |
|---|---|---|---|---|---|---|---|---|---|
| | EXAMPLES | | | | | | | EXAMPLES | |
| | 11 | 12 | 13 | 14 | 15 | 16 | 17 | 3 | 4 |
| TRANSFER | 100 | 100 | 100 | 100 | 100 | 100 | 100 | 0 | 0 |
| SURFACE | | | | | | | | | |
| AREA (%) | | | | | | | | | |
| PENCIL | 3H | H | 2H | 2H | 2H | H | H | (4H) | (5H) |
| HARDNESS | | | | | | | | | |

The results obtained in Examples 11 through 17 and shown in Table 7 demonstrate that the transfer material comprising a transfer layer composed of a cured resin layer obtained by curing the photocurable resin composition comprising components (A), (B) and (C) makes possible the complete transfer of the transfer layer onto the transferred product. Further, the pencil hardness of the transferred cured resin layer was H to 3H and a good surface hardness was obtained.

By contrast, the results of Comparative Examples 3 and 4 demonstrate that when the values of (Awt)/{(Awt)+(Bwt)} and (Bwt)/{(Awt)+(Bwt)} are outside the range in accordance with the present invention, the transfer layer cannot be transferred at all even when the polymer having thermal adhesiveness of component (A) is contained.

### Examples 18 through 21 and Comparative Example 5

A solution comprising 3 parts of silica ultrafine powder (mean particle size 20 nm), 3 parts of methyltriethoxysilane, 0.2 part of acetic acid, 54 parts of isopropyl alcohol, and 40 parts of ethanol was coated by a gravure coating method on a bidirectionally stretched polyethylene terephthalate film with a thickness of 38 μm and the coating was dried to form a layer of a material with predominantly siloxane bonds and a thickness of 0.09 μm. Photocurable resin compositions in which 20 parts by weight of the compositions (parts by weight) shown in Table 8 were dissolved in a diluting agent composed of 50 parts by weight of toluene and 30 parts by weight of isopropyl alcohol were coated with a bar coater to a thickness of 20 μm on the layer of material with predominantly siloxane bonds. The coatings were dried for 30 seconds at a temperature of 140° C. and cured by conducting UV irradiation two times with a 80 W high-pressure mercury lamp (conveyor speed 1 m/min, distance between the light source and irradiation object 10 cm, manufactured by Ushio Co., Ltd.) to form transfer layers composed of a cured resin layer and to obtain transfer materials.

Wettability (whether “cissing” and “pinholes” have appeared or not) of the cured resin layer with respect to the layer of material with predominantly siloxane bonds (low-refractive layer) was evaluated for the obtained transfer materials by measuring the surface area (%) of the cured resin layer related to the layer of material with predominantly siloxane bonds. The results obtained are shown in Table 8.

TABLE 8

| | | | | | COMPARATIVE |
|---|---|---|---|---|---|
| | EXAMPLES | | | | EXAMPLE |
| COMPONENTS | 18 | 19 | 20 | 21 | 5 |
| iso-PMMA^{*11} | 8 | 8 | 8 | 20 | 0 |
| syn-PMMA^{*12} | 17 | 0 | 0 | 40 | 0 |
| syn-PMMA^{*13} | 0 | 17 | 0 | 0 | 0 |
| syn-PnBMA^{*14} | 0 | 0 | 22 | 0 | 0 |
| EQ-MODIFIED BPADA^{*15} | 50 | 50 | 45 | 30 | 66 |
| DPEHA^{*16} | 25 | 25 | 25 | 10 | 34 |
| PHOTOPOLYMERIZATION | 3 | 3 | 3 | 3 | 3 |
| INITIATOR^{*17} | | | | | |
| (Awt)/{(Awt) + (Bwt)} | 0.25 | 0.25 | 0.25 | 0.6 | 0.0 |
| (Bwt)/{(Awt) + (Bwt)} | 0.75 | 0.75 | 0.75 | 0.4 | 1.0 |
| V (mol/L) | 6.0 | 6.0 | 5.9 | 2.8 | 6.3 |
| δ (cal/cm³) | 10.3 | 10.3 | 9.7 | 9.7 | 10.1 |
| COVER SURFACE AREA | 100 | 100 | 100 | 100 | 0 |

Notes for Table 8:
*¹¹iso-PMMA manufactured in Synthesis Example 1, Mw = 50,000, isotacticity 93%.
*¹²Trade name: Parapet HR-L, manufactured by Kuraray Co., Ltd., Mw 100,000, syndiotacticity 60%.
*¹³Trade name: Parapet LW-1000, manufactured by Kuraray Co., Ltd., Mw 38,000, syndiotacticity 60%.
*¹⁴syn-PnBMA manufactured in Synthesis Example 2, Mw = 37,000, isotacticity 57%.
*¹⁵Epoxy-modified Bisphenol A diacrylate, trade name: Viscoat #540, manufactured by Osaka Organic Chemical Industry Co., Ltd.
*¹⁶Dipentaerythritol hexaacrylate, trade name: DPHA, manufactured by Nippon Kayaku Co., Ltd.
*¹⁷Trade name: Irgacure 184, manufactured by Japan Ciba-Geigy Co., Ltd.

The results of Examples 18 through 21 shown in Table 8 demonstrate that if iso-poly(methyl methacrylate) and syn-poly(methyl methacrylate) are used together as a thermoadhesive polymer, a cured resin layer can be obtained with good coverage ratio even on the surface with low wettability.

By contrast, the results of Comparative Example 5 demonstrate that a surface with low wettability cannot be coated with a cured resin layer, without using a polymer of component (A) having thermal adhesiveness.

### Example 22

A solution comprising 3 parts by weight of silica ultrafine powder (mean particle size 20 nm), 3 parts by weight of methyltriethoxysilane, 0.2 part by weight of acetic acid, 54 parts by weight of isopropyl alcohol, and 40 parts by weight of ethanol was coated by a gravure coating method on a bidirectionally stretched polyethylene terephthalate film with a thickness of 38 μm, which has been subjected to release treatment, and the coating was dried to form a low-refractive layer with a thickness of 0.09 μm. A solution comprising 2.75 parts by weight of titanium oxide ultrafine powder (mean particle size 20 nm), 1.25 parts by weight of epoxy-modified bisphenol A diacrylate, 0.75 part by weight of triazine triacrylate, 0.25 parts by weight of a photopolymerization initiator, 30 parts by weight of ethanol, 15 parts by weight of isopropanol, 15 parts by weight of butanol, and 35 parts by weight of methyl ethyl ketone was coated with a bar coater on the layer of material with predominantly siloxane bonds thus obtained, dried for 30 seconds at a temperature of 140° C. and cured by conducting UV irradiation two times with a 80 W high-pressure mercury lamp (conveyor speed 1 m/min, distance between the light source and irradiation object 10 cm, manufactured by Ushio Co., Ltd.) to form a high-refractive layer. Then, the solution of Example 6 (described in Table 3) was coated with a bar coater, dried for 30 seconds at a temperature of 140° C. and cured by conducting UV irradiation two times with a 80 W high-pressure mercury lamp (conveyor speed 1 m/min, distance between the light source and irradiation object 10 cm, manufactured by Ushio Co., Ltd.) to form a transfer layer composed of a cured resin layer and to obtain a transfer material.

The transfer layer of the transfer material obtained was transferred onto a methacrylic resin sheet under the following conditions: sheet temperature 90° C., roll temperature 160° C., sheet feed speed 1 m/min, and a transferred product having a transfer layer transferred thereonto was obtained. The following results were obtained in evaluating the transferred product: transfer surface area 100%, pencil hardness 2H, minimum reflectivity in visible light range (400 to 700 nm) 0.5%.

The low-refractive layer and high-refractive layer were then removed with a methanol-infiltrated nonwoven fabric. Acetone was thereafter coated by the method described in JIS K 5600-6-1 to a film thickness of 100 μm and allowed to stay at normal temperature until it dried. The difference (ΔH) between haze values before and after acetone coating was measured. The result was 1.3, the pencil hardness was 2H.

With the transfer material according to the second aspect of the present invention, the transfer layer can be provided with both the hard coat function and the thermoadhesive function. Further, a homogeneous coating film can be obtained on a substrate material where “cissing” or “pinholes” can easily occur. Therefore, manufacture can be conducted at a low cost. Moreover, because transfer can be conducted with good transfer efficiency, the transferred product can be advantageously manufactured.

1-6. (canceled)

7. A method for the manufacture of a laminate comprising a cured resin layer on a substrate, the method comprising the following steps (a) and (b) of:
(a) forming on the substrate a coating film comprising a curable resin composition comprising the following components (A) to (C):
(A) a thermoadhesive polymer,
(B) an ethylenic unsaturated compound polymerizable by active energy radiation, and
(C) a polymerization initiator, where
the curable resin composition satisfies the relationships represented by the following formulas (1) and (2):
0.1≦(Awt)/{(Awt)+(Bwt)}≦0.6 (1)
0.4≦(Bwt)/{(Awt)+(Bwt)}≦0.9 (2)
where
(Awt) stands for a compounded amount (parts by weight) of component (A), and
(Bwt) stands for a compounded amount (parts by weight) of component (B); and
(b) irradiating the coating film with active energy radiation, thereby polymerizing the ethylenic unsaturated compound of component (B) contained in the coating film and forming the cured resin layer.

8. A laminate comprising a cured resin layer on a substrate, wherein the laminate is obtained by the method of claim 7.

9. The laminate according to claim 8, wherein
when acetone is coated on the cured resin layer, the difference between the haze value of the cured resin layer before the coating with acetone and the haze value of the cured resin layer after the coating with acetone is in the range of 0.3 to 40; and
the pencil hardness of the cured resin layer is no less than H.

10. A transfer material comprising
a release base film; and
a transfer layer on the release base film, wherein
the transfer layer comprises at least one thermoadhesive cured resin layer produced by curing a curable resin composition comprising the following components (A) to (C):
(A) a thermoadhesive polymer;
(B) an ethylenic unsaturated compound polymerizable by active energy radiation; and
(C) a polymerization initiator, where
the curable resin composition satisfies the relationships represented by the following formulas (1) and (2):
0.1≦(Awt)/{(Awt)+(Bwt)}≦0.6 (1)
0.4≦(Bwt)/{(Awt)+(Bwt)}≦0.9 (2)
where
(Awt) stands for a compounded amount (parts by weight) of component (A), and
(Bwt) stands for a compounded amount (parts by weight) of component (B); and
a layer of the at least one thermoadhesive cured resin layer forms an outermost surface of the transfer layer opposite the release base film.

11. The transfer material according to claim 10, wherein the transfer layer further comprises an antireflective layer.

12. The transfer material according to claim 10 or 11, wherein the transfer layer further comprises a layer of a material with predominantly siloxane bonds.

13. The transfer material according to claim 10 or 11, wherein
when acetone is coated on the layer of the at least one thermoadhesive cured resin layer, the difference between the haze value of the layer of the at least one thermoadhesive cured resin layer before the coating with acetone and the haze value of the layer of the at least one thermoadhesive cured resin layer after the coating with acetone is in the range of 0.3 to 40; and
the pencil hardness of the layer of the at least one thermoadhesive cured resin layer is no less than H.

14. A method for the manufacture of a transfer material comprising
a release base film; and
a transfer layer comprising at least one cured resin layer on the release base film, the method comprising the following steps (a′) and (b′) of:
(a′) forming on the release base film a film comprising a curable resin composition comprising the following components (A) to (C):
(A) a thermoadhesive polymer;
(B) an ethylenic unsaturated compound polymerizable by active energy radiation; and
(C) a polymerization initiator, where
the curable resin composition satisfies the relationships represented by the following formulas (1) and (2):
0.1≦(Awt)/{(Awt)+(Bwt)}≦0.6 (1)
0.4≦(Bwt)/{(Awt)+(Bwt)}0.9 (2)
where
(Awt) stands for a compounded amount (parts by weight) of component (A), and
(Bwt) stands for a compounded amount (parts by weight) of component (B); and
(b′) irradiating the film comprising the curable resin composition with active energy radiation to form a thermoadhesive cured resin layer.

15. A transferred product obtained by transferring onto a transfer substrate the transfer layer of the transfer material of claim 10 or 11.

16. The transferred product according to claim 15, wherein
when acetone is coated on the layer of the at least one thermoadhesive cured resin layer, the difference between the haze value of the layer of the at least one thermoadhesive cured resin layer before the coating with acetone and the haze value of the layer of the at least one thermoadhesive cured resin layer after the coating with acetone is in the range of 0.3 to 40; and
the pencil hardness of the layer of the at least one thermoadhesive cured resin layer is no less than H.
